(19) United States
(12) Patent Application Publication
(10) Pub. No.: US 2026/0157346 A1
(43) Pub. Date: Jun. 11, 2026

(54) FOLDING HANDRAIL STRUCTURE FOR PET RAMPS

(71) Applicant: SHENZHEN HUIKAIDA TECHNOLOGY CO., LTD, Shenzhen (CN)

(72) Inventor: He Zhang, Guangzhou (CN)

(73) Assignee: SHENZHEN HUIKAIDA TECHNOLOGY CO., LTD, Shenzhen (CN)

(21) Appl. No.: 19/000,777

(22) Filed: Dec. 24, 2024

(30) Foreign Application Priority Data
Dec. 9, 2024 (CN) 2024230251309

(51) Int. Cl. A01K 29/00

(52) U.S. Cl. CPC A01K 29/00

(57) ABSTRACT

This invention provides a folding handrail structure for pet ramps, comprising: a support component, the support component includes a first support plate, hinges, a second support plate, and a storage groove, the hinges are fixedly installed at one end of the bottom of the first support plate, the second support plate is fixedly installed at one end of the bottom of the hinges, the storage grooves are respectively provided on both sides of the first support plate and the second support plate; a regulating component. This invention provides a folding handrail structure for pet ramps, which through the cooperation of the support component, regulating component, and protective component, etc., can open the protective component during pet exercise, allowing the protective component to block the sides of the support component, preventing pets from falling off the sides of the support component, thereby enhancing safety.

### TECHNICAL FIELD

The present invention relates to the field of pet supplies technology, and particularly to a folding handrail structure for a pet ramp.

### BACKGROUND TECHNOLOGY

Pets are animals raised by people to alleviate loneliness or for entertainment needs among the numerous types of pets cats and dogs are the most numerous having undergone long-term evolutionary changes cats and dogs have gradually moved away from the original biological chain of nature no longer directly participating in maintaining ecological balance but instead perfectly adapting to human family life deeply integrating into peoples daily routines and work scenarios with pet dogs being particularly common.

As society continues to advance and the enthusiasm for pet ownership continues to rise, the market for pet-related products is becoming increasingly vibrant with growing demand. In terms of household scenarios, to ensure that pet dogs get adequate exercise, numerous innovative products have emerged on the market. For example, one such product is a folding slide that uses several parallel sliding boards connected by rotating links. The sides of the sliding boards are equipped with side panels, and the surface of the sliding boards is covered with sandpaper. The bottom surface of the sliding boards features several stepped slots. This invention is applied to pet exercise.

However, the slide lacks protective components, and pet dogs are likely to fall from the side of the slide when climbing, thus reducing the safety.

Therefore, it is necessary to provide a folding handrail structure applied to the pet ramp to solve the above technical problems.

### INVENTION CONTENT

The invention provides a folding handrail structure for pet ramp, which solves the problem of lack of protective components and reduces safety.

In order to solve the above technical problems, this invention provides a folding handrail structure applied to pet ramp, including:
Supporting components, the supporting components include the first support plate, hinges, the second support plate, and the storage groove, the hinges are fixedly installed at one end of the bottom of the first support plate, the second support plate is fixedly installed at one end of the bottom of the hinges, and the storage grooves are respectively provided on both sides of the first support plate and the second support plate;
The regulating component, said regulating component is set at the bottom of the support component, said regulating component includes a shaft, support frame, positioning rod, positioning frame, and positioning groove, said shaft is fixedly installed at one end of the bottom of the first support plate, said support frame is rotably connected to the outer side of the shaft, said positioning rod is fixedly installed at the bottom inside of the support frame, said positioning frame is rotably connected to the other end of the first support plate, said positioning groove is provided on one side of the positioning frame;
The protective components are respectively set on both sides of the first support plate and the second support plate, the protective components include cross rods and two first rotating rods, the two first rotating rods are rotably connected to both ends of one side of the cross rod, and the two first rotating rods are respectively rotably connected to both sides of the first support plate and the second support plate.

Preferably, the positioning slot is provided with multiple, and the positioning rod is set on the inner side of one of the said positioning slots.

Preferably, the other end of the first support plate is provided with a blocking component, which includes a railing and two second rotating rods. The two second rotating rods are respectively pivotally connected to the ends of one side of the railing, and one side of the bottom of the two second rotating rods is pivotally connected to the other end of the first support plate.

Preferably, the bottom of the adjusting frame is internally fixed with a rotating rod, and the two ends of the rotating rod are rotably connected with rollers.

Preferably, the other end of the second support plate is provided with a plug-in plate on both sides, one end of which is fixedly installed with an installation block, and a universal wheel is fixedly installed at the bottom of the installation block.

Preferably, locking screws are fixedly installed on both sides at the other end of the bottom of the second support plate.

Preferably, one end of the locking screw is pressed against the bottom of the plug-in plate.

Compared with the related technology, the folding handrail structure provided by the invention for application in pet ramp has the following beneficial effects:

This invention provides a folding handrail structure for pet ramps, which, through the cooperation of supporting components, adjusting components, and protective components, can be unfolded when exercising pets, allowing the protective components to block the side of the supporting components to prevent pets from falling off the side of the supporting components, thereby enhancing safety.

### ATTACHED FIGURE DESCRIPTION

FIG. 1 is a schematic diagram of the first embodiment of a folding handrail structure for a pet ramp provided by the present invention;

FIG. 2 is another perspective structure diagram of the FIG. 1;

FIG. 3 is a schematic diagram of the folding structure of the railing assembly shown in FIG. 1;

FIG. 4 is a schematic diagram of the overall folded structure shown in FIG. 1;

FIG. 5 is a structural diagram of a second embodiment of a folding handrail structure for a pet ramp provided by the invention;

FIG. 6 is an enlarged view of part A shown in FIG. 5;

Figure markings: 1. Support Component, 11. First Support Plate, 12. Hinge, 13. Second Support Plate, 14. Storage Slot, 2. Adjustment Component, 21. Pivot Shaft, 22. Support Frame, 23. Positioning Rod, 24. Positioning Frame, 25. Positioning Slot, 3. Protective Component, 31. Cross Rod, 32. First Turning Rod, 4. Obstruction Component, 41. Fence, 42. Second Turning Rod, 5. Turning Rod, 51. Roller, 6. Plug-in Plate, 61. Installation Block, 62. Universal Wheel, 63. Locking Screw.

### SPECIFIC IMPLEMENTATION METHODS

The present invention is further described with reference to the drawings and embodiments.

### First Embodiment

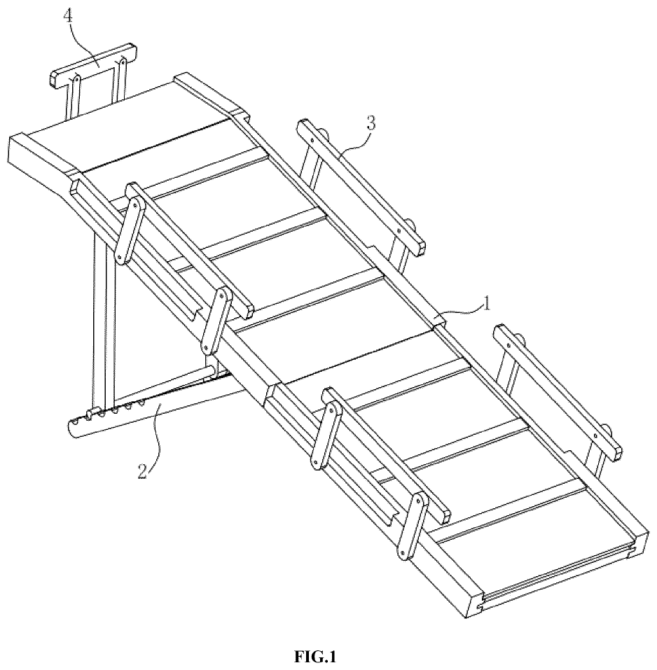

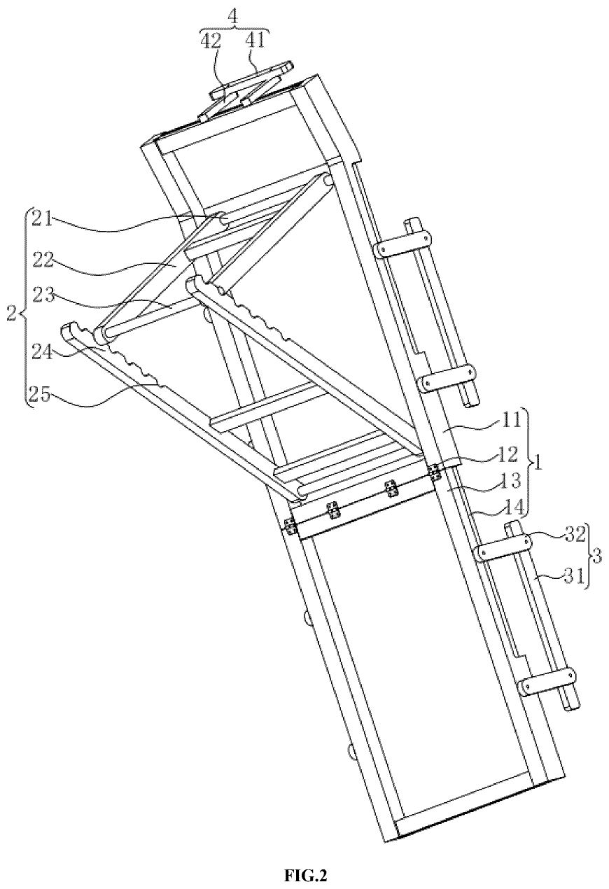

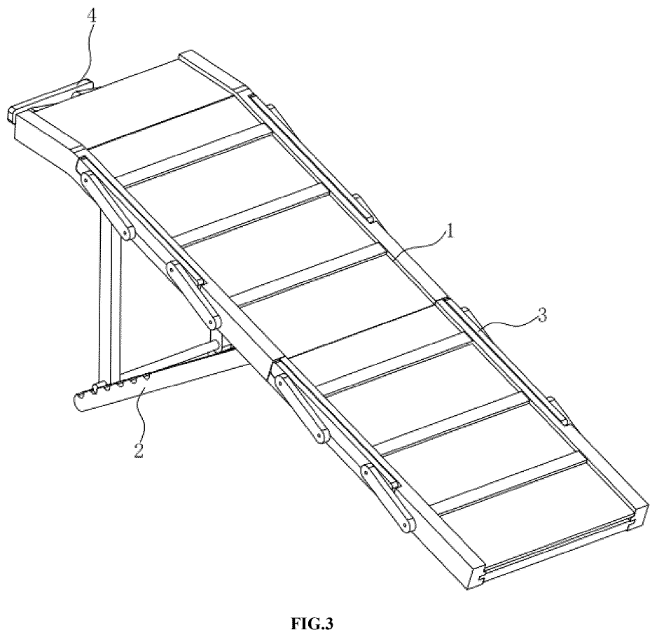

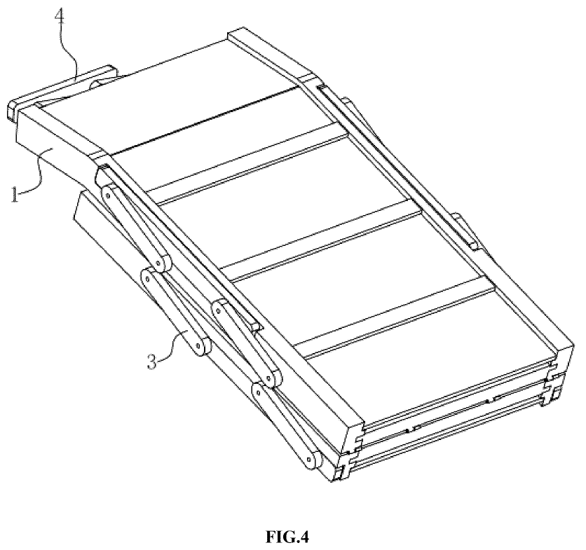

Please refer to FIGS. 1, 2, 3, and 4, where FIG. 1 is a schematic diagram of the structure of the first embodiment of a folding handrail structure provided by this invention for use in pet ramps; FIG. 2 is another perspective view of the structure shown in FIG. 1; FIG. 3 is a schematic diagram of the folding structure of the handrail assembly shown in FIG. 1; FIG. 4 is a schematic diagram of the overall folded structure shown in FIG. 1.

A folding handrail structure for use in pet ramps comprises: a support component 1, which includes a first support plate 11, hinges 12, a second support plate 13, and a storage groove 14, where the hinges 12 are fixedly installed at one end of the bottom of the first support plate 11, and the second support plate 13 is fixedly installed at one end of the bottom of the hinges 12, and the storage grooves 14 are provided on both sides of the first support plate 11 and the second support plate 13.

Regulating Component 2, said regulating component 2 is set at the bottom of the support component 1, said regulating component 2 includes a shaft 21, a support frame 22, a positioning rod 23, a positioning frame 24, and a positioning groove 25, said shaft 21 is fixedly installed at one end of the bottom of the first support plate 11, said support frame 22 is rotably connected to the outer side of the shaft 21, said positioning rod 23 is fixedly installed inside the bottom of the support frame 22, said positioning frame 24 is rotably connected to the other end of the first support plate 11, said positioning groove 25 is provided on one side of the positioning frame 24.

Protection Component 3, said Protection Component 3 is respectively set on the sides of the First Support Plate 11 and the Second Support Plate 13, said Protection Component 3 includes Cross Rod 31 and two First Turning Rods 32, the two First Turning Rods 32 are rotably connected at both ends of one side of the Cross Rod 31, the two First Turning Rods 32 are respectively rotably connected at both sides of the First Support Plate 11 and both sides of the Second Support Plate 13.

When the protective component 3 is not required to be used, the protective component 3 can be folded to store the crossbar 31 into the inner side of the storage slot 14, thereby reducing the space occupied;

The first support plate 11 and the second support plate 13 are connected by hinge 12 so that after use, the first support plate 11 and the second support plate 13 can be rotated and folded to reduce the space occupied.

The positioning slot 25 is provided with multiple positioning slots, and the positioning rod 23 is provided on the inner side of one of the positioning slots 25.

The positioning rod 23 is inserted into the inner side of different positioning slots 25, so that the inclination angle of the support component 1 can be adjusted. In this way, the height at which the pet dog climbs can be adjusted according to the actual situation, so as to adapt to different pet dogs for use, thus increasing the adaptability of the device.

The other end of the first support plate 11 is equipped with a blocking component 4, which includes a railing 41 and two second rotating rods 42. The two second rotating rods 42 are respectively pivotally connected at their ends on one side of the railing 41, and one side at the bottom of the two second rotating rods 42 is pivotally connected to the other end of the first support plate 11.

By setting the blocking component 4, the end of the supporting component 1 can be blocked to prevent the pet dog from falling from one end of the supporting component 1, thus increasing the safety.

The working principle of the folding handrail structure for pet ramp provided by the invention is as follows:

After the use, the user can move the four cross rods 31 to the sides of the first support plate 11 and the second support plate 13 respectively, thereby rotating the first rotating rod 32 around the sides of the first support plate 11 and the second support plate 13 as well as the cross rods 31, thus repositioning the cross rods 31 inside the recessed groove 14. Then push the railing 41 to rotate the second rotating rod 42, which allows for the repositioning of the railing 41. Next, move the positioning rod 23 out from the inner side of the positioning groove 25, and subsequently rotate the support frame 22 and the positioning frame 24 to reposition them at the bottom of the first support plate 11. Finally, connect the first support plate 11 and the second support plate 13 via hinges 12, rotating the second support plate 13 to the bottom of the first support plate 11, thereby folding and storing the slide track to reduce space occupation.

Compared with the related technology, the folding handrail structure provided by the invention for application in pet ramp has the following beneficial effects:

By supporting the structure of support component 1, adjustment component 2 and protective component 3 to cooperate with each other, when exercising the pet, the protective component 3 can be opened up to block the side of support component 1, so as to prevent the pet from falling from the side of support component 1, thus increasing the safety.

### Second Embodiment

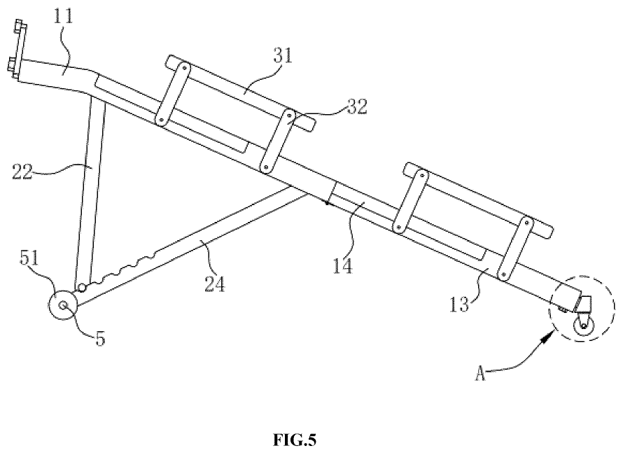

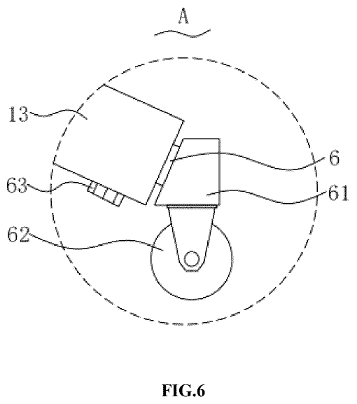

Please refer to FIG. 5 and FIG. 6, a folding handrail structure for pet ramps is provided based on the first embodiment of this application, while the second embodiment proposes another folding handrail structure for pet ramps. The second embodiment is merely an optional approach to the first embodiment, and the implementation of the second embodiment will not affect the separate implementation of the first embodiment.

Specifically, the second embodiment of this application provides a folding handrail structure for pet ramps that differs in that a folding handrail structure for pet ramps is provided, wherein a rotating rod 5 is internally fixedly installed at the bottom of the positioning frame 24, and both ends of the rotating rod 5 are rotably connected to rollers 51.

The other end of the second support plate 13 is provided with a plug plate 6 on both sides, and one end of the plug plate 6 is fixedly installed with an installation block 61, and the bottom of the installation block 61 is fixedly installed with a universal wheel 62.

The other end of the bottom of the second support plate 13 is fixedly installed on both sides with locking screws 63.

One end of the locking screw 63 is pressed against the bottom of the plug plate 6.

The roller 51 and the universal wheel 62 are cooperated with each other, so that it is convenient for the user to adjust the direction of the track when pushing the track, and the universal wheel 62 has a self-locking structure, which can play a limiting role.

The working principle of the folding handrail structure for pet ramp provided by the invention is as follows:

When in use, the plug-in plate 6 can be inserted into the interior of the second support plate 13, then the locking screw 63 can be turned to ensure that one end of the locking screw 63 contacts the bottom of the plug-in plate 6, thereby limiting the movement of the plug-in plate 6. This allows for the installation of the universal wheel 62, enabling subsequent use where the roller 51 and the universal wheel 62 can roll over the ground, facilitating the users adjustment of the devices track position.

Compared with the related technology, the folding handrail structure provided by this invention for pet ramp has the following beneficial effects:

By rotating the rod 5, roller 51, plug-in plate 6, mounting block 61, universal wheel 62, and locking screw 63, etc., they cooperate with each other to enable the roller 51 and universal wheel 62 to roll on the ground during use, thus facilitating the users movement of the devices position, thereby increasing the mobility of the device.

The above-described is merely an embodiment of the invention and does not therefore limit the scope of the patent rights of the invention. Any equivalent structural or equivalent process transformation made by utilizing the contents of the specification and drawings of the invention, or directly or indirectly applied in other related technical fields, are equally included within the scope of the patent protection of the invention.

What is claimed is:

1. A folding handrail structure for a pet ramp, characterized in that it comprises:
Supporting components, the supporting components include the first support plate, hinges, the second support plate, and a storage groove, the hinges are fixedly installed at one end of the bottom of the first support plate, the second support plate is fixedly installed at the top of the hinges at one end of its bottom, the storage grooves are respectively provided on both sides of the first support plate and the second support plate;
The regulating component, said regulating component is set at the bottom of the support component, said regulating component includes a shaft, a support frame, a positioning rod, a positioning frame, and a positioning groove, said shaft is fixedly installed at one end of the bottom of the first support plate, said support frame is pivotally connected to the outer side of the shaft, said positioning rod is fixedly installed inside the bottom of the support frame, said positioning frame is pivotally connected to the other end of the first support plate, said positioning groove is provided on one side of the positioning frame;
The protective components are respectively set on both sides of the first support plate and the second support plate, the protective components include a crossbeam and two first rotating rods, the two first rotating rods are rotably connected to both ends of one side of the crossbeam, and the two first rotating rods are respectively rotably connected to both sides of the first support plate and both sides of the second support plate.

2. A folding handrail structure for a pet ramp according to claim 1, characterized in that, the positioning slot is set up with multiple, and the positioning rod is set up on the inner side of one of the positioning slots.

3. A folding handrail structure for a pet ramp according to claim 1, characterized in that the other end of the first support plate is provided with a blocking component, the blocking component comprising a railing and two second rotation rods, the two second rotation rods are respectively pivotally connected at one end of each side of the railing, and one side of the bottom of the two second rotation rods is pivotally connected at the other end of the first support plate.

4. A folding handrail structure for a pet ramp according to claim 1, characterized in that the bottom of the adjusting frame is fixedly installed with a rotating rod, and both ends of the rotating rod are rotably connected with rollers.

5. A folding handrail structure for a pet ramp according to claim 1, characterized in that the second support plate is provided with a plug-in plate on both sides at its other end, the plug-in plate is fixedly installed with an installation block at one end, and the bottom of the installation block is fixedly installed with a universal wheel.

6. A folding handrail structure for a pet ramp according to claim 5, characterized in that, the second support plate is fixedly installed on both sides at the other end of the bottom side.

7. A folding handrail structure for a pet ramp according to claim 6, characterized in that one end of the locking screw is pressed against the bottom of the plug-in plate.
